(19) United States
(12) Patent Application Publication
(10) Pub. No.: US 2002/0133448 A1
(43) Pub. Date: Sep. 19, 2002

(54) System for capturing trade information

(76) Inventors: Glenn McGarry, Holbrook, NY (US); Wesley Fedorchak, Walnut Creek, CA (US)

Correspondence Address: FITZPATRICK CELLA HARPER & SCINTO, 30 ROCKEFELLER PLAZA, NEW YORK, NY, 10112, US

(21) Appl. No.: 09/764,782

(22) Filed: Jan. 17, 2001

(51) Int. Cl. G06F 17/60

(52) U.S. Cl. 705/37

(57) ABSTRACT

A trade capture system is provided which includes a first computer having an interface for capturing executed trade data, a second computer for accepting the captured trade data and performing middle and back office processing on the same, and a communication channel for communicating the captured trade data between the first and second computers.

### BACKGROUND OF THE INVENTION

1. Field of the Invention

The present invention relates to an automated trade capture system having a client interface.

2. Related Background Art

Various automated systems already exist for executing trades among brokers, market managers, individual traders and other financial entities. See, for example, U.S. Pat. Nos. 4,674,044, 5,950,176, and 5,963,923. In addition, a few large brokerages have developed on-line trading systems for individual traders. These systems, however, do not provide for middle office and back office processing, such as by an investment bank acting either as a principal or a clearing agent, of a trade previously executed between two parties.

Such middle and back office processing has been performed internally by the investment bank of Lehman Brothers, in an in-house version of its SMARTTICKET™ automated trade capture system. In this system, executed trade information was captured by Lehman Brothers personnel from written documents sent to them from external clients. The captured trade information was then sent through a workflow process consisting of trader and middle office trade authorizations, as well as back office processing.

However, while being automated, this in-house system did not permit any trade capture to be performed by the clients themselves. Further, the trades were mostly limited to derivatives.

A client-assessable trade capture system is desirable, however, because it would provide clients with a single trade capture platform, in which products besides derivatives, such as cash and futures trades, may be handled, which in turn provides the investment house a competitive advantage. A client-assessable trade capture system would also provide the clients with links to the internal risk, margin and counterparty services of the investment bank, access to historical trade activity, as well as trade validation and confirmation.

### SUMMARY OF THE INVENTION

To overcome the above-described and other limitations in the art, the present invention relates to a system that preferably provides an efficient and streamlined system for capturing trades that can be operated by the client at its site.

In one aspect of the present invention, a trade capture system is provided that includes a first computer having an interface for capturing executed trade data, a second computer for accepting the captured trade data and performing middle and back office processing on the same, and a communication channel for communicating the captured trade data between the first and second computers. Preferably, the first computer is a client computer, the second computer is an investment bank computer, and the communication channel is the Internet, wherein the client computer's interface is a browser.

In another aspect of the present invention, a trade capture system is provided which includes a first computer having an interface for transmitting electronic trade tickets, a second computer for receiving the electronic trade tickets and performing middle and back office processing on the same, and a communication channel for communicating the electronic trade tickets between the first and second computers.

These and other aspects of the present invention are described in more detail below.

### BRIEF DESCRIPTION OF THE DRAWINGS

FIG. 1 is a state diagram showing the states and actions (“workflow”) of the present invention.

FIG. 2 is a screen shot of a graphical user interface of the present invention relating to a new deal.

FIG. 3 is a screen shot of a graphical user interface of the present invention relating to a swap accelerator.

FIG. 4 is a screen shot of a graphical user interface of the present invention relating to a generic swap.

FIG. 5 is a screen shot of a graphical user interface of the present invention relating to a swap leg of Party A.

FIG. 6 is a screen shot of a graphical user interface of the present invention relating to a swap leg of Party B.

FIG. 7 is a screen shot of a graphical user interface of the present invention relating to a trade authorization.

FIG. 8 is a screen shot of a graphical user interface of the present invention relating to risk management details.

FIG. 9 is a screen shot of a graphical user interface of the present invention relating to a deal filter.

FIG. 10 is a screen shot of a graphical user interface of the present invention relating to a deal workflow history.

FIG. 11 is a block diagram of the system architecture of the present invention.

### DETAILED DESCRIPTION OF THE PREFERRED EMBODIMENTS OVERVIEW

The following describes as a preferred embodiment of the present invention Lehman Brothers' SMARTTICKET™ client-based trade capture system that was first made publicly available on Jan. 17, 2000. However, the following description is not limited to that system, and may include additional features not present in that system.

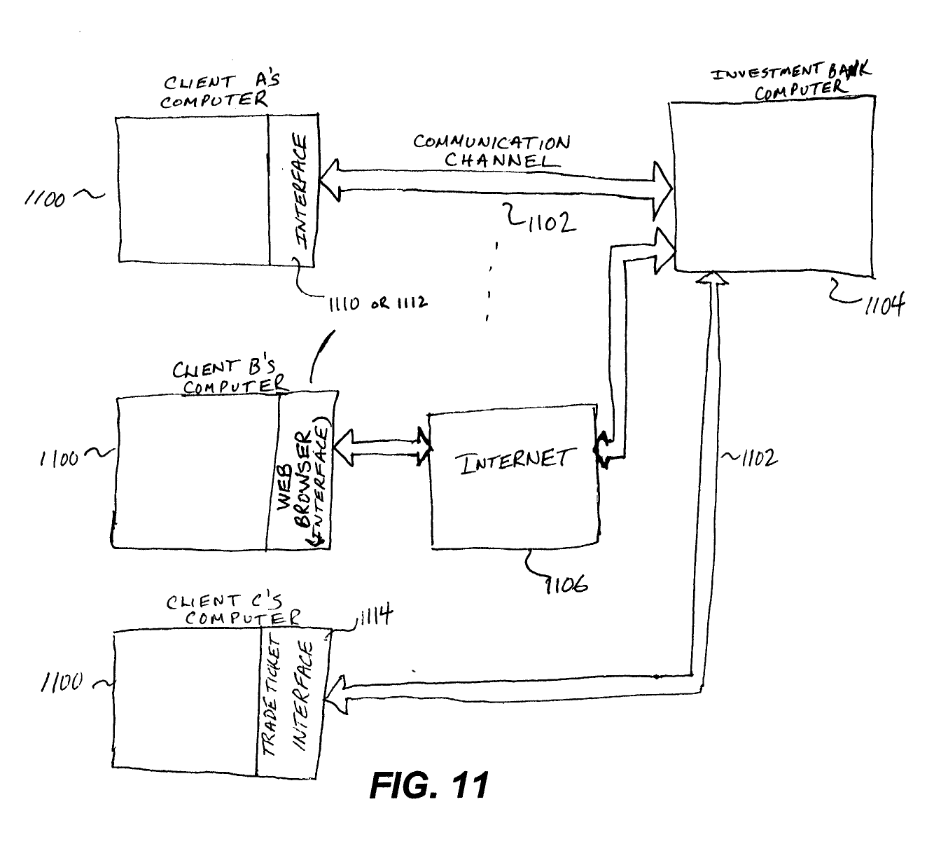

An embodiment of the present invention is shown in FIG. 11, and includes a client computer 1100, a communication channel 1102, and the investment bank's middle office and back office processing computer system 1104. As shown in that figure, the client computer 1100 of the present invention is installed at the client's site, and is preferably connected to the investment back's computer system 1104 through the Internet 1106. Of course, other types of well-known communication channels 1102 may be employed instead to connect and communicate information between the client computer 1100 and the investment bank's computer system 1104.

Executed trades may be entered directly into the system's interface 1110 on the client's computer. Alternatively, the client may have its own interface 1112 which connects to the system of the present invention, and in that case, the trades are entered by the client into its own interface, which in turn are transmitted through the Internet or other communication channel to the system 1104.

Additionally, the system 1104 may receive from the client's computer 1100, via the electronic trade ticket interface 1114, over the Internet or communication channel, trade tickets which contain the executed trade data. This eliminates, or at least reduces, the need for the client to key trade data into its interface. The investment back system 1104 accepts those trade tickets electronically, preferably using XML technology, on a real-time basis.

Because it is desirable for the system 1104 to support as many clients as possible, it supports a wide variety of trades besides traditional derivatives. Accordingly, the system 1104 is described below with respect to trades, such as swaps, swaptions, caps, floors, FX, and cash, related to derivatives, futures and cash products, including both U.S. and non-U.S. products. However, it will be appreciated that the system may be extended to accept executed trades of other financial products. As will be described in more detail below, to give clients more flexibility to trade in both derivatives and cash products, templates exits for both the derivatives and cash business. For example, these templates allow for the capture of outright bond trades, financing trades and futures and options trades.

Separate entities within the investment bank system 1104 are set up according to product type, mainly for security and safekeeping purposes. For example, for U.S. products and for global derviatives, separate entities are set up for each client in the respective internal system. For non-U.S. cash products, a separate entity is also used to segregate the client's financing trades to properly keep them (i.e., for client reporting and balance sheet purposes). In addition, for U.S. cash products, a unique bank depository may be set up for each client, while for non-U.S. cash products, a investment bank or bank/depository account may be used. Separating each client's data provides a security layer to the system, because a client can view and access only its own trades and no others. Further, a profile may be set up for each client, in which the client is restricted to access only certain products (e.g., swaps), allowing the client to trade in only those products for which it signed up for.

In addition, to support hedge funds clients, the client's interface 1104 supports a client allocation function. This function allows the client to enter a single trade and then allocate that trade into multiple trades (i.e., multiple funds) based on the allocation breakdown specified by the client. This function significantly speeds up the trade capture process for those clients.

Further, the client's interface may includes a trade blotter screen developed for that client's business. This blotter gives the client the ability to sell of its trades, across different product types, on one integrated screen. Data may be viewed for the current day of any date range entered.

Once the trade data have been captured by the system 1104, the trade data may be routed to the appropriate internal system of the investment house, based on the product. The investment bank may then verbally confirm, on trade date, the trade that the client has executed with its street counter-party. This trade may be confirmed with the investment bank acting as either a principal or as a clearing agent. Once the trades are confirmed, they may be settled by the investment bank, for which the investment bank moves either the cash or securities based on the client's instructions. The client may then be notified of the trade settlement by the investment bank, for example, by its computer system, through the communication channel, to the client's computer.

Deal Capture

This section describes a preferred embodiment of capturing deal information in the system of the present invention. Deal capture begins with specification of the product type to be captured. This allows the system to provide the user with a template for capturing the specific information needed for that deal. Field entry is simplified, because values for as many fields as possible are defaulted based on product type. As fields are populated, other fields are assigned default values based on that information. Field entry may then be validated for all fields. Files may then be saved and named in preparation of moving deals into the system workflow, which is also described in detail below.

System menus and toolbars may be configured similar to Microsoft applications, with all functions available on drop-down menus at the top of the screen. Selected functions are available as buttons on the system toolbar. The user preferably has access to all functions through both mouse and keystroke selection. If any function cannot logically be performed by a user based on the user profile, deal state, or mode of file access, that menu item is made inactive. Inactive menu items are stippled (shaded light gray).

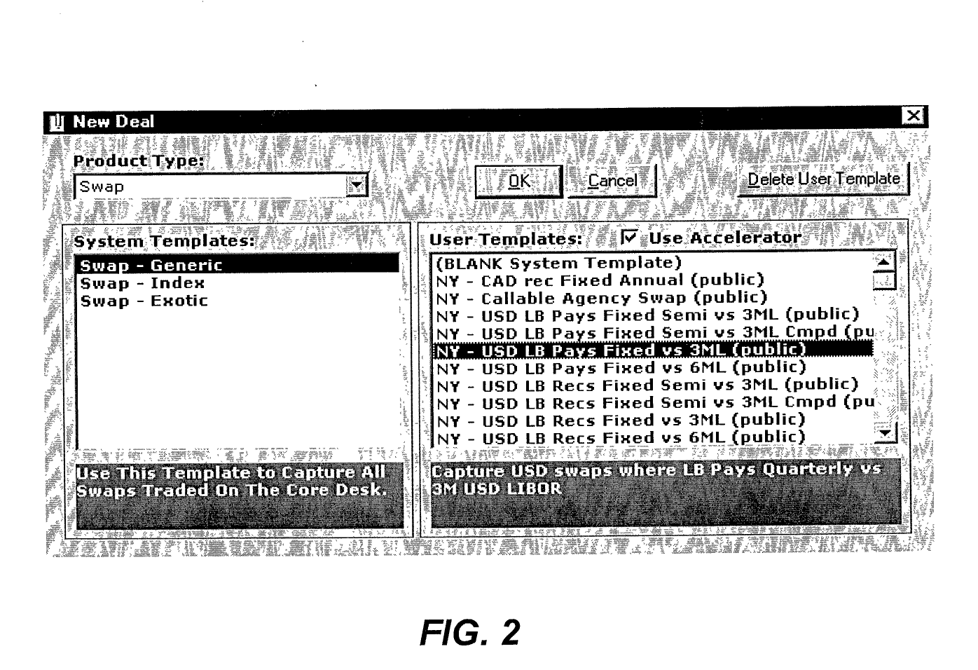

As shown in FIG. 2, new deals are created by first selecting a senior product type and a subordinate product type, which together define the structure and data fields needed to capture that deal.

For example:

Senior Product Type=Interest Rate Swap

Subordinate Product Type=Generic Fixed vs. Floating

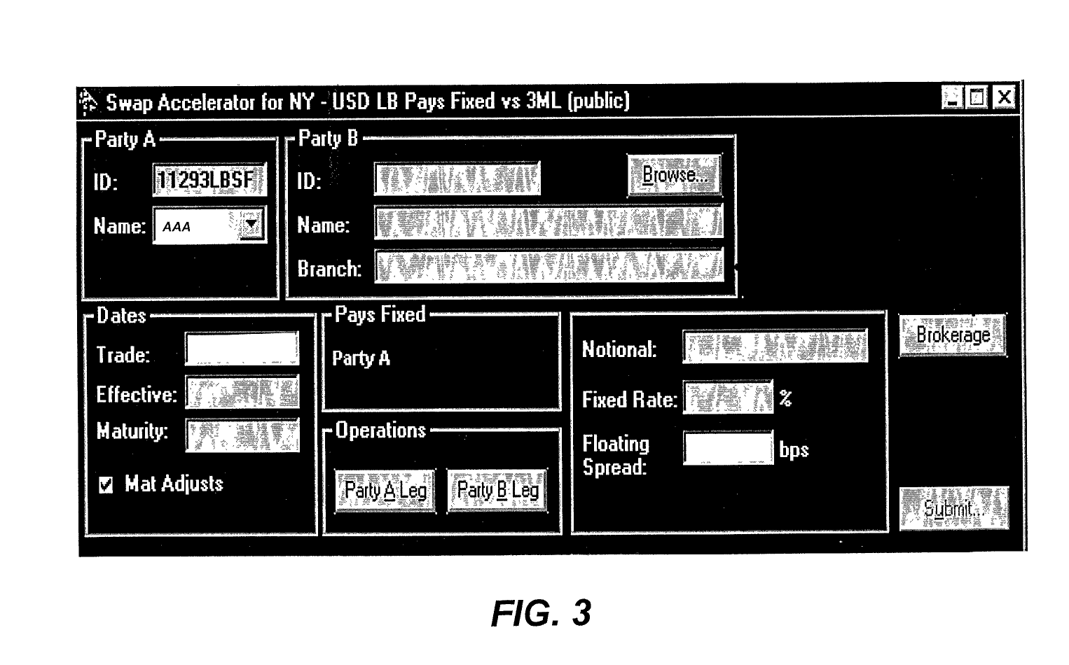

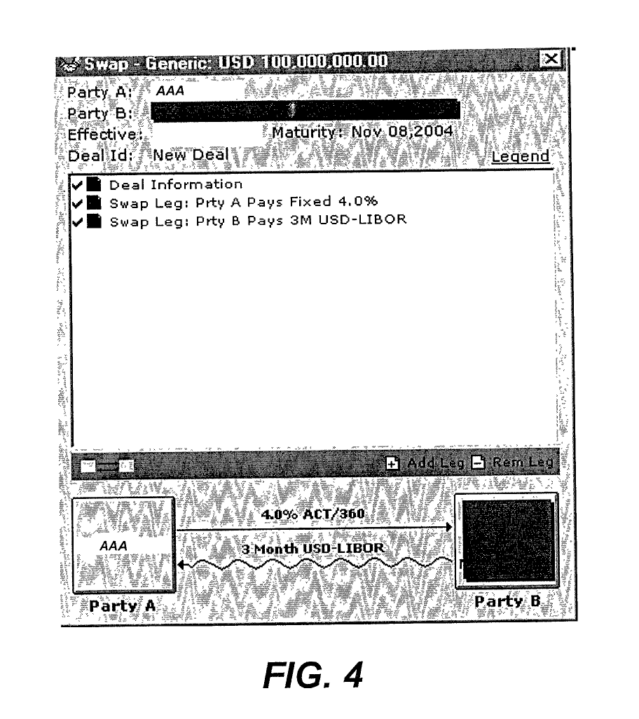

A template may then be stored in system for each combination of senior and subordinate product types. As new deal structures are recognized, new product types may be defined, and new templates may be created by system users. In addition to the system templates created for all users, each user will be able to create custom (or “user”) templates for individual or shared use. The user will be able to choose from the lists of system and custom templates to initiate deal capture. The client's interface preferably only contains the system templates. FIGS. 3 and 4 respectively show a swap accelerator and a generic swap generated by the client using the templates.

When the first piece of deal information is captured, the selected template becomes a “Deal in Progress”, which is the first valid deal state (102) in the system workflow. The Deal in Progress is assigned an ID within system that remains with the Deal in Progress until it becomes an authorized deal, or is deleted. The Deal in Progress belongs exclusively to the user creating it until it is explicitly shared with other users, called a Deal in Progress Transfer. The ticket will remain in the user inbox of the creator until it is sent to another user for processing.

In the system of the present invention, Party A may be selected to be the investment bank entity. The defaulting investment bank entity is based on user preferences and can be changed based on a choice list of valid investment bank entities. As for the counterparty (Party B), a counterparty browser allows the selection of that party directly from an entity master database. This ensures that deals are booked with valid counterparties. In addition to counterparty name, branch, and ID, other information about the counterparty stored on the entity master database are viewable. Preferably, none of the information in the entity master database is editable from the system of the present invention itself, and thus is separately edited. In cases where the counterparty has not yet been set up on the entity master database, the option to enter the counterparty as “TBD” (To Be Determined) with a free-format name is provided. Replacement of the “TBD” counterparty with a counterparty from the entity master database may be enforced by preventing the deal from reaching its final state until the “TBD” counterparty issue is resolved.

System field entry consists of populating the selected template with deal information. In most cases, fields will have a default value based on the product type, or the values of other fields. The user may override these defaults, however, usually by picking from a choice list of values.

Field values are typically validated according to validation rules recorded in the system. If a field value is determined to be invalid, an error message is displayed and the focus will remain on that field. Where applicable, fields may be validated in the context of the values of other fields on the ticket.

The system also includes a field propagation engine, which is used to propagate the effects of one changed field value on other fields. A change in one field may propagate such changes to other fields such as making them visible or invisible, changing their default values, and determining whether they are required or not required.

Required fields are those fields that must be populated given the selected product type, the values of other fields that have already been populated, and the state of the deal (which states are described in detail below). If a field is required given these parameters, the system does not allow the deal to transition to the next state. There are no fields required for a ticket to exist in the Deal in Progress state. All economic data fields are preferably required before trader authorization can occur.

A limited free-format comment field is provided on each template to capture information that cannot be captured on an existing template. This comment field is monitored by the middle office so that an appropriate custom template can be constructed.

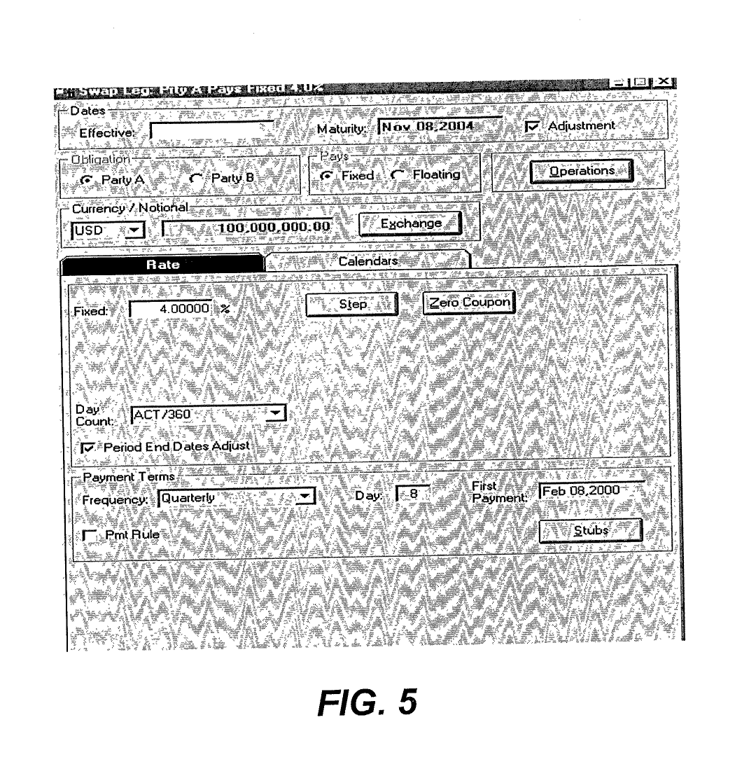

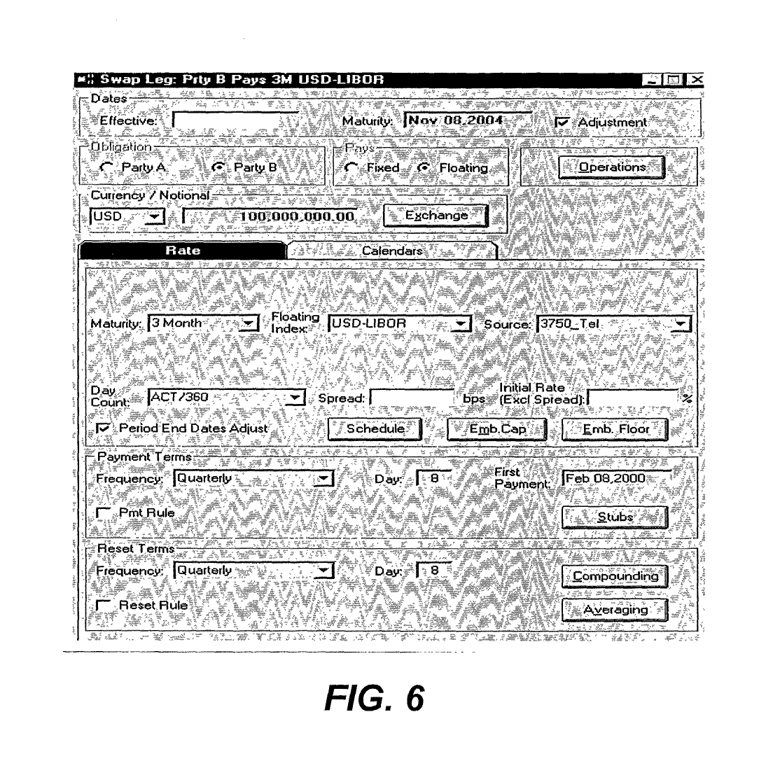

System deal legs may be selected, copied, and pasted within deals or from one deal to another. The deal the leg is being copied from may be open in Write Mode or Read-only Mode, but the deal the leg is being pasted onto must typically be open in Write Mode. If a deal is open in Write Mode, legs may be selected and deleted. Legs may also be chosen from a menu of available legs to be inserted onto a deal. A display of swap legs is shown in FIGS. 5 and 6.

During deal capture, the system periodically saves captured deal information to a temporary file to minimize data loss due to an interruption in network service or an unanticipated PC re-boot. The temporary save occurs every pre-determined number of minutes (e.g., five minutes), and the temporary file is deleted when the user explicitly closes the file, which is known as a “clean close”. When logging on to the system, the user is advised of any files that were not “closed clean” when the user last logged out. The user may then be given the option to recover the last autosaved version of the file.

A file may be saved as a Deal in Progress or as a custom template. If a deal in progress has not previously been explicitly saved, the user may be prompted to save the file as a Deal in Progress or as a custom template. If the file has been previously saved, or if the file is an authorized deal, the updated version of the file may be saved in place of the old version. Any file may be saved as a Deal in Progress. None of the fields on a system or custom template are required for a file to be saved as a Deal in Progress. Any file open in Write Mode or Read-only Mode may be saved as a custom template. The resulting custom template will be “owned” by the user who created it, and will be available only to that user unless explicitly changed by that user.

Preferably, system file names consist of the originating office, the trade date, the Party A ID, the Party B ID, and a user-defined free-format portion. This free-format portion is created by the user who originates the deal, and may be changed only by that user unless “ownership” of that deal is explicitly changed.

System Workflow

This section describes a preferred embodiment of the workflow of the system of the present invention. System workflow entails moving a ticket through a series of states, each closely associated with a group of users that must process the ticket in each state. There are five valid deal states: Deal in Progress 102, (Deal) Pending Trader Authorization 104, (Deal) Pending AAA Authorization (105), (Deal) Pending Middle Office Processing (106), and Active Deals in Back Office (107). In the basic workflow, a Deal in Progress is created by the client or by a marketer, who populates most of the deal information fields and obtains the necessary credit and AAA approvals (AAA approvals are simply an extra level of authorization required for certain deals by the investment bank). The Deal in Progress of state 102 is then submitted for trader authorization, entering the Pending Trader Authorization state 104. When authorized, the deal then moves to the Pending Middle Office Processing state 106. When this is complete, the ticket is authorized to the final state, Active Deals in Back Office 107. If the deal is an AAA trade, it must pass through the additional state 105 of Pending AAA Authorization before reaching the Pending Middle Office Processing state 106. At any time after the ticket becomes an authorized deal, users will be able to Attach Proposed Edits to the ticket and re-submit it for Trader Authorization. The system workflow also handles processing of terminations and assignments.

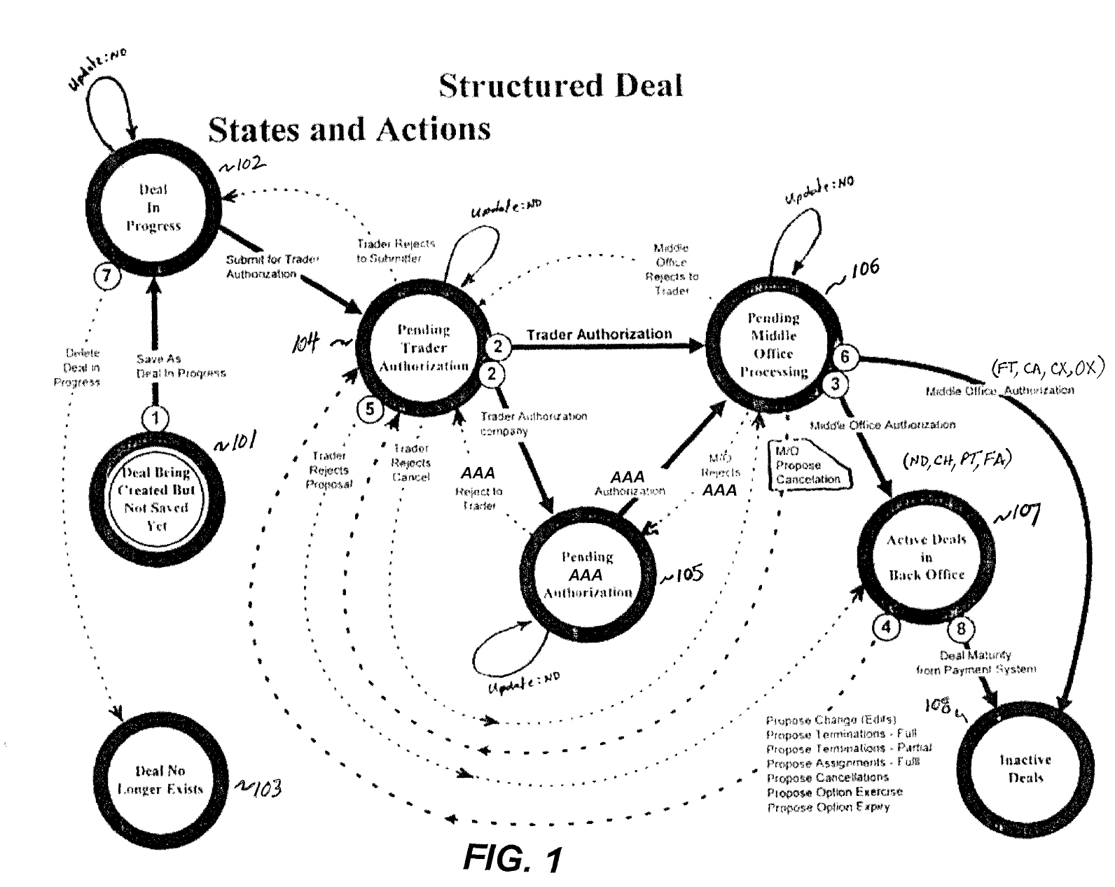

FIG. 1 is a state diagram showing the states and actions of the system workflow. Each large circle represents one state that the executed trade, or “deal”, may take while being processed by the system. The thick, dark arrows represent successful movements in which the deal goes forward. The dotted lines represent deal deletions or rejections, or a rejection by the trader of a proposal from the middle office or back office. The dashed lines represent proposals from the middle office or back office.

In state 101 “Deal Being Created But Not Saved Yet”, the client enters into the graphical user interface of the system the required trade information, as well as other deal-related information, as explained further below. When all necessary information has been entered, the client saves the deal, which brings the workflow to state 102, “Deal in Progress”.

In state 102, two actions may occur: the client may delete the deal in progress, in which case the workflow moves to state 103, “Deal No Longer Exists”. At that point, the deal dies and no further action is taken.

Alternatively, the deal is submitted to the trader for authorization, in which case the workflow moves to state 104, “Pending Trader Authorization”. In this state, the trader may authorize or reject the deal. If the deal is rejected, the workflow returns to state 102, at which point the client may update the deal in progress and resubmit for authorization, or may delete the deal.

As stated above, in state 104, the deal may be authorized by the trader, in which case the workflow moves to state 106, “Pending Middle Office Processing”. In certain cases, which are explained in further detail below, the deals must be additionally authorized by AAA and before being sent to the middle office for processing. In this case, the deal is sent to state 105, “Pending AAA authorization”. Upon AAA authorization, the workflow moves to state 106 for middle office processing. Otherwise, if AAA rejects the deal, the workflow returns to state 104, at which point the deal may be updated or rejected back to the client.

In state 106, the middle office may authorize the deal, and depending upon the deal action type, either sends it to the back office, in which case the workflow moves to state 107 “Active Deals in Back Office”, or to the inactive deals, in which case the workflow moves to state 108 “Inactive Deals”. Upon deal authorization, the client is notified of the same.

Alternatively, the middle office may reject the deal back to the trader, in which case the workflow returns to state 104, or to the AAA authorizer, in which case the workflow returns to state 105. In the former case, the trader may update the deal and resubmit it to the middle office (to state 106), or may instead send the rejected deal back to the client (to state 102). In the latter case, the AAA authorizer can update the deal and resubmit it to the middle office (to state 106), or may instead send the rejected deal back to the trader (to state 104), which is handled by the trader as described above.

In addition, the middle office may propose that the deal be canceled, in which case the workflow returns to state 104. The trader may then cancel the deal and notify the client, or may reject the proposed cancellation, in which case the workflow returns to state 106.

Deals are characterized by an action type (listed with its associated abbreviation), including but not limited to:

New deals: ND;
Change (aka Correct/Edit): CH;
Termination - Full: FT;
Termination - Partial: PT;
Assignment - Full Only: FA;
Cancellation: CA;
Option Exercise: CX; or
Option Expiry: OX.

Further, deal in progress may be saved or deleted, new deals may be rejected, deals may mature, and proposals may be rejected.

If the deal action is a full termination, a cancellation, and option exercise or an option expiry, all of which represent of inactive deals, the middle office authorizes the deal to be sent to state 108. Otherwise, if the deal is a new or corrected deal, or involves a partial termination or an assignment, all of which represent active deals, the deal is sent to the back office for further processing (in accordance with the required action), state 107. In addition, the deal may mature via the payment system of the back office, in which case it becomes inactive and the workflow moves to state 108.

The back office may make certain proposals to the deal to the trader, as follows: changes (edits); full terminations; partial terminations; assignments; cancellations; option exercise; or option expiry. These proposals move the workflow back to the trader in state 104. The trader in turn may update the deal to reflect the proposal, in which case the workflow proceeds from state 104 as described above (i.e, to states 102, 105 or 106), or the trader may reject the proposal back to the back office, state 107.

In addition, the small circles represent points (1)-(8) at which external publication may occur be the printing of “drop copies,” described in more detail below.

In the system of the present invention, each state has a group of users responsible for processing the ticket while it is in that state. When processing in a given state has been completed, a user may move the ticket onto the desktops of the users responsible for processing in the next state, which is called herein the “State Transition Process”. Each time a ticket is submitted for authorization or is authorized, a dialog box may be displayed. Within this dialog box, the user may specify which users, or group of users, should be prompted to process the ticket next. The dialog box preferably has a default, pre-selected user or group of users who are responsible for processing in the next state. However, it is possible to include more users to the workflow through this dialog box, but the ability to exclude users is preferably restricted.

As a ticket moves from a Deal in Progress from user to user through the workflow, it appears in the user inbox of the user(s) responsible for processing it. The user inbox is preferably represented by an on-screen indicator which provides notification of the number of deals awaiting processing by that user or group of users. The user may be notified of the arrival of new deals for processing. By selecting this indicator with the mouse, a user can view a list of unprocessed deals. The time each item was received in the user inbox may also be displayed. The user can drill down directly from the list into the deal awaiting processing.

In addition to routing tickets for workflow purposes, system users may also send informational messages to other system users. When moving tickets from one state to another, the same dialog box used to move the ticket to the next user in the workflow also allows distribution of an FYI Message to other users not directly in the workflow. The user receiving the FYI Message can read the message and drill down to the ticket attached to it in Read-only Mode. FYI Messages may also be sent directly at any point in the system, with no deal attachment. The user is preferably notified of the arrival of new FYI Messages. Each user typically has an on-screen indicator that provides notification of the number of unread FYI messages in the user's queue. By selecting this indicator with the mouse, a user can view a list of all messages. The time each message was received may also be indicated. Read items are preferably differentiated from unread items, and the user can delete any item.

Each user can display a dialog box with a summary of items in the user inbox and the FYI message queue.

Ownership of a Deal in Progress may be handed off from user to user before being submitted for trader authorization, which is called herein a “Deal in Progress Transfer”. A dialog box is preferably displayed allowing the first user to specify which user will own and process the ticket next. While the Deal in Progress Transfer appears to be similar to the State Transition Process, the movement of a Deal in Progress from the queue of one user to another is a lateral transfer with no state change.

Before an “AAA” Deal in Progress becomes an authorized deal, it must be approved by an AAA business manager. This approval is initially obtained during a phone call between the trading desk and the AAA business manager. The marketer or trader preparing the ticket typically records the name of the person granting AAA approval on the Deal in Progress.

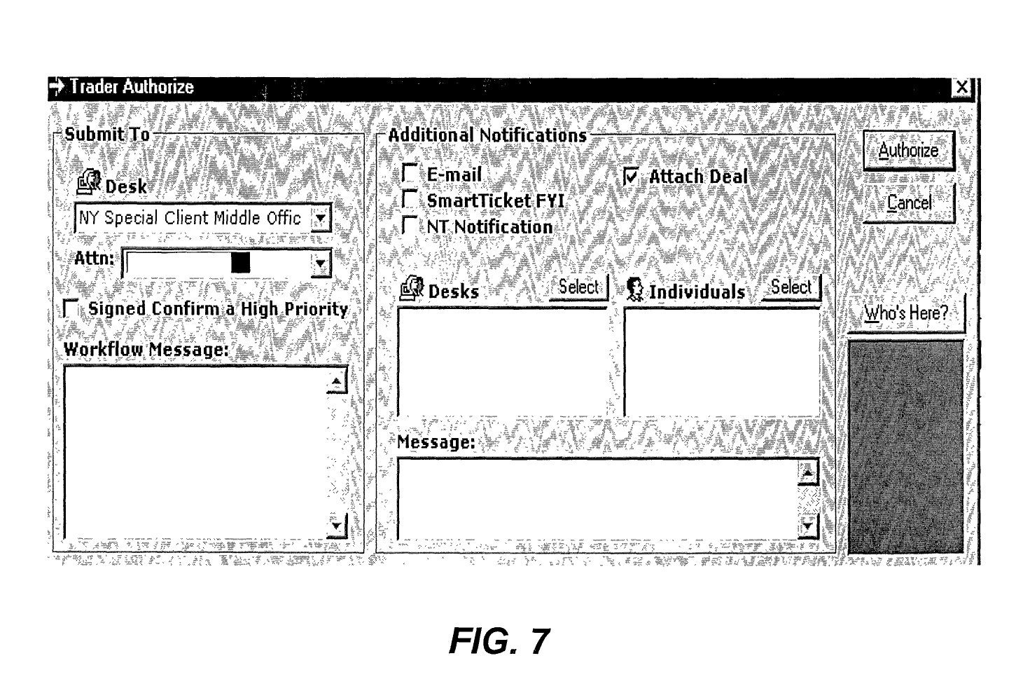

A Deal in Progress enters the system workflow by being submitted to a trader for authorization. (See FIG. 7) This function can be performed by a marketer submitting a Deal in Progress to a trader, or by a trader submitting a Deal in Progress to another trader. Upon submission, the state of the Deal in Progress will change to Deal Pending Trader Authorization 104, and the trader will be prompted to authorize it.

During Trader Authorization, a Deal Pending Trader Authorization becomes an authorized deal for processing by Middle and Back Office users. In the case where there is no marketer in the workflow, a trader may authorize a deal directly from the Deal in Progress state 102 to the Middle Office Processing state 106. Preferably, all required fields are checked for population and all fields are validated. If these criteria are met, the Deal in Progress ID is relinquished, and a unique, permanent ID is assigned to the authorized deal.

A deal requiring AAA authorization must be authorized by an AAA business manager before moving to the Pending Middle Office Processing state 106 (an initial authorization by the AAA business manager was previously done while the Deal in Progress is created, as described above). The trader authorizing an AAA trade is advised that the trade is being submitted for AAA authorization, and the state of the deal changes to Pending AAA Authorization 105. AAA system users subsequently authorize the deal to the Pending Middle Office Processing state 106.

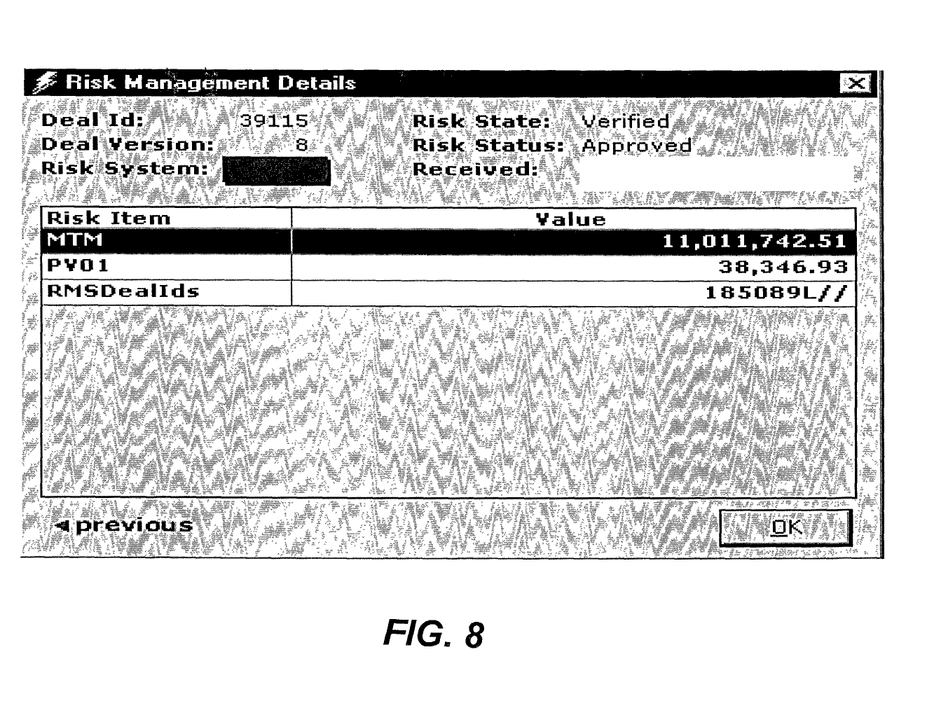

Middle office authorization occurs when the deal has been captured on all relevant risk management and payment systems. (See FIG. 8) The deal then enters its final active state, Active Deals in Back Office 107.

After trader authorization, users may propose changes to a deal by entering Proposed Edit Mode. Certain aspects of the on-screen appearance of the deal, such as the desktop background color, preferably change to indicate that the deal is in Proposed Edit Mode. System fields that are editable in at least one state then become editable. An optional free-format comment field may also be made available to users to capture an explanation of the proposed edit.

Once proposed edits have been attached, a deal is typically re-submitted for trader authorization in state 104. Usually, the trader who initially authorized the deal becomes responsible for accepting or rejecting proposed edits.

Once submitted, proposed edits preferably appear in the user inbox of the trader who originally authorized the deal. A proposed edit symbol appears next to deals with attached proposed edits to differentiate them from other Deals Pending Trader Authorization. The trader can select the item with the mouse and view a summary of proposed edits, which include both the original and proposed values of the fields being edited. The user proposing the edit, the time the edit was proposed, and the comment explaining the edit may also be displayed.

A trader may apply or reject all proposed edits, or selectively apply or reject edits to specific fields. If at least one proposed edit is applied, the amended ticket is sent through the workflow. If all of the proposed edits are rejected, the ticket is not resent through the workflow. In either case, the user who submitted the proposed edit is typically advised of which edits were applied or rejected.

The cancellation process works like the proposed edit process, except that it is a separate menu item, and that users propose cancellation of the deal in its entirety, rather than modification of selected fields. A cancellation ticket is sent through the workflow.

Terminations and assignments are processed very similarly to proposed edits in system. The process may be initiated and authorized at the trader level, or initiated downstream and submitted for trader authorization. In cases of termination or assignment, the user is typically prompted for termination or assignment fee information, legal effective date, and economic effective date.

For full termination, the termination ticket is sent through the workflow. For partial termination, the user is preferably prompted for the terminated notional amount. The original ticket with amended notional amount is then sent through the workflow. For a full assignment, the user is preferably prompted to enter a new Party A or Party B. The original ticket with amended Party A or Party B is then sent through the workflow. In the case of partial assignment, the user is preferably prompted for the assigned notional amount and the new Party A or Party B for the assigned amount. A new Deal in Progress for the assigned amount may then be authorized by the trader and sent through the workflow. The original ticket with amended notional amount is then sent through the workflow.

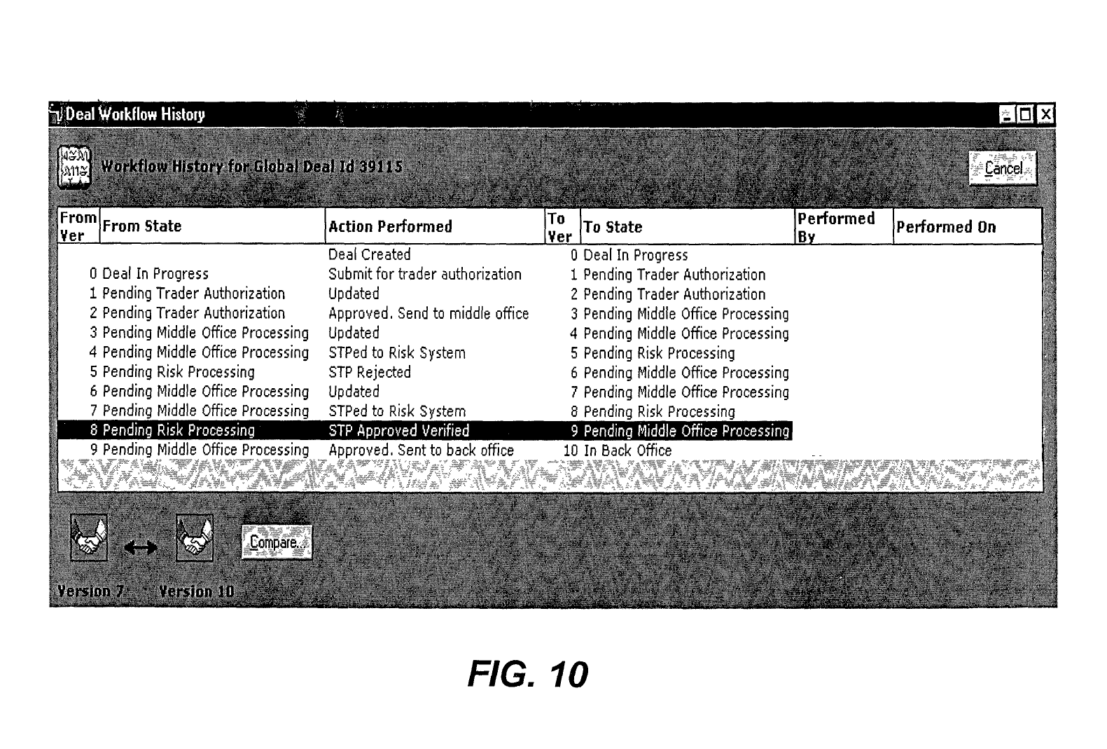

An audit trail of all changes made to an authorized deal may be maintained. Each time a proposed edit to a deal is applied by a trader, a static copy of the historical version of the deal is stored on the database. The user can display a dialog box summarizing the changes. The user can also select any change with the mouse and display a complete historical version of the deal. The user can further display a dialog box summarizing the deal's current state and an audit trail of its state transition history. The state transition history records state transitions, the name of the user initiating the state transition, and the time it was initiated (see FIG. 10). The confirmation status of the deal may also be displayed, including whether the confirmation has been sent, or signed and returned. This feature thus permits a client to access the state transition history of a deal.

File Processing

This section describes a preferred method of processing filed in the system of the present invention. Files may be Custom Templates, Deals in Progress, or authorized deals.

New files in the system may be created as Deals in Progress or Custom Templates. A Deal in Progress is created when a System Template, a Custom Template, or an authorized deal is saved by the user as a Deal in Progress. A Custom Template is created when a System Template, a Custom Template, or an authorized deal is saved by the user as a Custom Template. This method of Creating New Files allows a user to open an existing file for the sole purpose of saving it as a new file owned by that user.

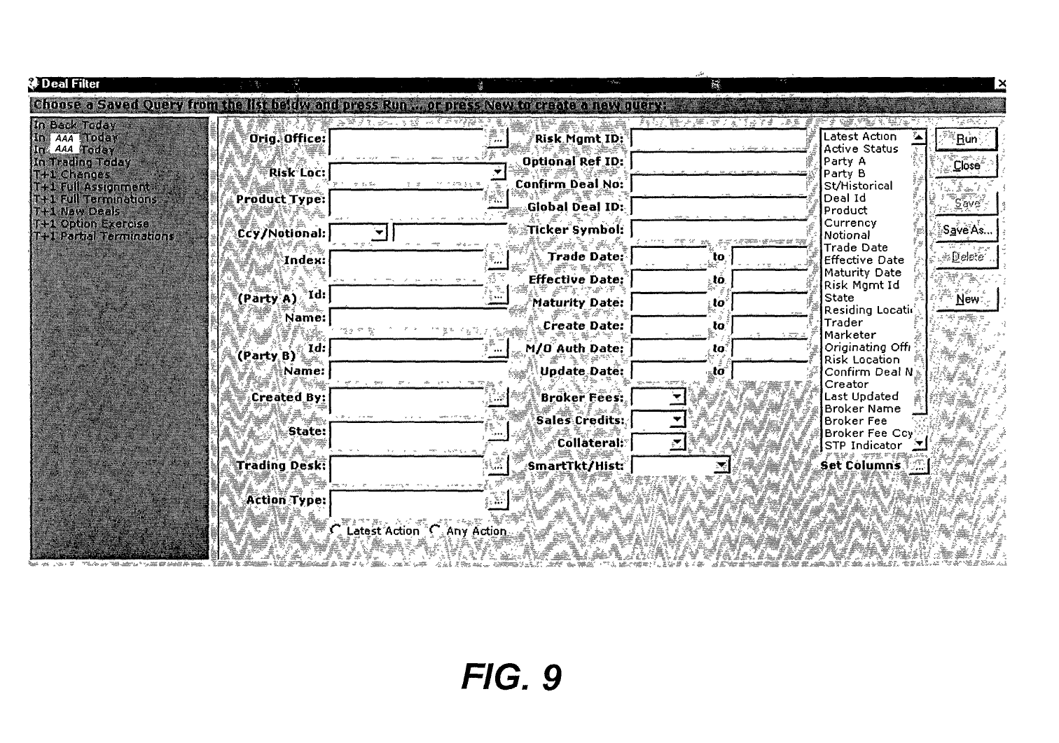

Users may browse files across all states in the system, may filter on approximately 50 fields (see FIG. 9), and may specify which fields are included in the result set. In addition to being able to drill down to the deal level directly from the file browser, the user can save favorite queries, and print or download result sets to a spreadsheet. In addition, the user can quickly re-access the four most recently used files in system.

System files may be opened by users in Write Mode, or in Read-only Mode. Whether a file may be opened, and it what mode it may be opened, is dependent on File Edit Permissions and File Write Lock. When a deal is open in Write Mode all system fields that a user has Edit Permissions for are editable. When a user attempts to open a file in Write Mode, the system checks whether that user already has another deal open for writing, or whether a second user has the same deal open for writing. If the first user already has a deal open for writing, the user is advised that two files cannot be simultaneously open for writing. The user then has the option of either closing the first file, or of opening the second file in Read-only Mode. If a second user has the same file open for writing, the first user is informed of the time the file was write locked, and the identity of the second user. The first user has the option of opening the second file in Read-only Mode.

File edit permissions are determined by deal state and user profile. When a user attempts to open a file in Write Mode, the system checks whether that user has permission to edit that file based on the functions associated with the group to which the user belongs. The system preferably checks whether the file is editable based on the state in which the deal is. In either case, the user is advised that the file is not editable, and the reason it is not editable. The user then has the option of opening the second file in Read-only Mode. When a deal is open in Read-only Mode, no system fields are editable.

Custom Templates and Deals in Progress are treated as the property of the user that creates them. Ownership of a Custom Template implies the ability to view it, to edit it, or to change viewing permissions, while ownership of a Deal in Progress implies the ability to view it, to edit it, or to enter it into the workflow. Files are generally viewable by all users through the deal browser, with the exception of Custom Templates and Deals in Progress. Since each user may be maintaining a number of Custom Templates and Deals in Progress, viewing will initially be limited to the file owner. Users can transfer Custom Template ownership to another user. This function is typically invoked if first user no longer wanted to maintain or control access to the Custom Template. Users also can share Custom Templates by opening up view permssions to other users. A user with view permissions would not be allowed to edit a Custom Template, but would be able to save and become the owner of a new version of it. Deal in Progress ownership and view permissions are changed in the system workflow as a Deal in Progress Transfer, described above.

Files that are open for writing may be “closed clean”. If the file was open in Read-only Mode, the file will be dismissed from the screen. If the file was open for writing, the user will be prompted to save changes.

Payment and Risk Management Views

This section describes a preferred payment and risk management views of the system of the present invention. The Payment (Customer) View of the deal is the way the deal is captured in system, and the way the deal is preferably referenced in documentation between the investment bank house and the counterparty. The Risk Management View of the deal is the way the legs of a deal must be broken up on the investment bank's risk management and payment systems. The system captures both views, as follows.

The payment view of a deal is created as deal information is captured. This is the default view in the system. Initially, the Risk Management View and the Payment View are the same. This is because in the case of generic deals, the payment legs of a deal may be acceptable as risk management legs. The Middle Office reviews all payment legs to verify that they can be booked in risk management systems. If a payment leg cannot be used as a risk management leg, however, the Middle Office has to create risk management legs in System. Middle Office users are then required to specify which risk management system on which each risk management leg is booked. When a deal is opened in Write Mode or in Read-only Mode, the Payment View will be presented. The user can switch to the Risk Management View by selecting a menu item. When the Risk Management View is being displayed it is preferably prominently indicated on the screen.

Administrative Function

This section describes the administrative functions preferably implemented in the system of the present invention. These administrative functions ensure that system security is enforced, that deal information is captured correctly, that new product types are identified and accounted for in the template structure, and that tickets move smoothly through the workflow.

User preferences are user level administration functions that allow customization of default settings, workflows, and filter criteria. The User Profile contains information about each user's System administrative privileges and group membership. This information is viewable at the user level, but editable only by someone with User Profile Administration privileges. Middle Office administrative users are preferably responsible for creating, updating, and deleting system User Profiles. Middle Office administrative users are also preferably responsible for maintaining system User Groups. This includes defining system privileges for each User Group and assigning individual users to User Groups.

Middle office administrative users are also preferably responsible for creating, updating, and deleting system System Templates, and monitoring the comment field of all deals for information that cannot be captured on an existing Template. If the data could have been captured on an existing Template, the user generates a proposed edit; otherwise, the user either adds an existing field to a System Template, or defines a new field and adds it to the System Template. By adding a new field, an existing System template may be modified, or a new System template may be created. The ticket may then be re-submitted for Trader Authorization as a proposed edit as described above, and the comment field is empty.

To ensure that tickets are processed in a timely manner, middle office administrative users preferably monitor the number of deals in the workflow in each state. Using the file browser, they can view deals across all states.

Additional Functions

This section describes certain additional functions which may be implemented to enhance the capturing and processing of deals, as described above. First, system users can print files open in Write Mode or Read-only Mode, and can select and deselect deal components to be printed through a dialog box. In addition, users can define the output format of the printed ticket. All print selections are viewable through a print preview function. Further, the system can generate “drop copies” of tickets at specified times, such as state transitions.

If a file is open for writing, the user may be allowed to discard any changes made to the file since it was opened by invoking a “revert to last saved version of a file” function. A dialog box asks the user to confirm the action and advises that any changes will be lost. If confirmed, the file is then closed without saving changes and the last saved version is re-opened.

If a file is open for writing, the user may be allowed to return all fields to their defaulting values by invoking a “revert to field defaults” function. A dialog box asks the user to confirm the action and advises that any changes to fields with defaulting values will be lost.

If a file is open for writing, the user may be allowed to clear all data, including defaulting values, from fields on the file by invoking a “clearing all fields” function. A dialog box will ask the user to confirm the action and advise that any data in fields will be lost.

Generic text edit functions, such as those typically found in Microsoft applications, are made available to the user. For example, the user may cut, copy, and paste text items.

Based on captured trade data, a graphical flow diagram of all legs is generated for viewing and printing.

While the present invention has been described in detail with reference to the preferred embodiments thereof, many modifications and variations thereof will be readily apparent to those skilled in the art. Accordingly, the scope of the invention is not to be limited by the details of the preferred embodiments described above, but only by the terms of the appended claims.

What is claimed is:

1. A trade capture system comprising:
a first computer having an interface for capturing executed trade data;
a second computer for accepting the captured trade data and performing middle and back office processing on the same;
a communication channel for communicating the captured trade data between the first and second computers.

2. A system according to claim 1, wherein the first computer is a client computer.

3. A system according to claim 1, wherein the second computer is an investment bank computer.

4. A system according to claim 1, wherein the communication channel is the Internet, and the interface is a browser.

5. A trade capture system comprising:
a first computer having an interface for transmitting electronic trade tickets;
a second computer for receiving the electronic trade tickets and performing middle and back office processing on the same;
a communication channel for communicating the electronic trade tickets between the first and second computers.
